(19) United States
(12) Patent Application Publication
(10) Pub. No.: US 2005/0136314 A1
(43) Pub. Date: Jun. 23, 2005

(54) Ion-exchange membrane for an electrochemical fuel cell

(75) Inventors: Charles Stone, West Vancouver (CA); Cindy Mah, Vancouver (CA); Paul F. Meharg, Vancouver (CA); Sean M. MacKinnon, Burnaby (CA); Scott J. McDermid, Vancouver (CA); Stephen S. Hamada, Vancouver (CA); Miho S. Hall, Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/738,914

(22) Filed: Dec. 17, 2003

(51) Int. Cl. C08J 5/22

(52) U.S. Cl. 429/33; 521/27

(57) ABSTRACT

A membrane electrode assembly has two gas diffusion layers, two catalyst layers and an ion-exchange membrane interposed therebetween wherein the ion-exchange membrane is cast from a sulphonated polyether ketone/sulfone ionomer. Specifically, the ionomer can be represented as A-B-C wherein 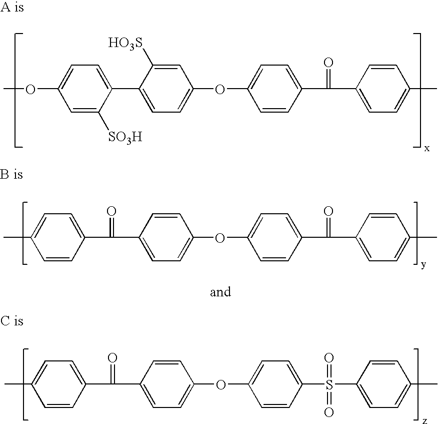
Further x, y, z represent the mole ratios of each moiety in the ionomer such that x is between 0.25 and 0.40; y is between 0.01 and 0.26; and z is between 0.40 and 0.67. Melt viscosity of the corresponding base polymer also affects performance in the fuel cell, particularly at values over 0.4 kNsm⁻² as measured at 400° C., 1000 s⁻¹. In preparing the membrane electrode assembly, the catalyst layers may be coated directly on the membrane and then bonded with two gas diffusion layers.

### BACKGROUND OF THE INVENTION

1. Field of the Invention

The present invention generally relates to ion-exchange membranes for electrochemical fuel cells and more particularly to ion-exchange membranes comprising sulphonated polymers.

2. Description of the Related Art

Electrochemical fuel cells convert fuel and oxidant to electricity and reaction product. Solid polymer electrochemical fuel cells generally employ a membrane electrode assembly (MEA) in which an electrolyte in the form of an ion-exchange membrane is disposed between two gas diffusion layers (GDLs). The GDLs are typically made from porous, electrically conductive sheet material, such as carbon fiber paper or carbon cloth. In a typical MEA, the GDLs provide structural support to the ion-exchange membrane, which is typically thin and flexible.

The MEA further contains an electrocatalyst, typically comprising finely comminuted platinum particles disposed in a layer at each membrane/GDL interface, to promote the desired electrochemical reaction. The GDLs are electrically coupled to provide a path for conducting electrons between the electrodes through an external load.

During operation of the fuel cell, at the anode, the fuel permeates the porous GDL and reacts at the electrocatically active site in the catalyst layer to form protons and electrons. Facilitated by water, the protons migrate through the ion-exchange membrane to the cathode. At the cathode, the oxygen-containing gas supply permeates the porous GDL and reacts at the cathode catalyst layer with the protons and electrons to form water as a reaction product.

The most common commercial ion-exchange membrane used is a sulphonated perfluorocarbon membrane sold by E.I. Du Pont de Nemours and Company under the trade designation NAFION®. Efforts have been ongoing to develop other types of membranes. In particular, Victrex Manufacturing Limited has several patent applications on a large class of sulphonated polyarylether ketone and/or sulphone ionomers (see WO00/015691; WO01/019896; WO01/070857; WO01/070858; WO01/071839; WO01/198696; WO02/075835; collectively referred to as the Victrex Prior Art). The Victrex Prior Art is hereby incorporated by reference in its entirety. While the Victrex Prior Art provides various examples where specific ionomers were prepared and various properties were measured, little to no actual fuel cell data is provided. It is only through testing in an actual fuel cell that it is possible to determine either the reliability, performance or durability of any particular membrane and thus its suitability for use within a fuel cell. As such, there remains a need for ion-exchange membranes suitable for the fuel cell environment.

### BRIEF SUMMARY OF THE INVENTION

After extensive fuel cell testing, unexpected performance and durability was observed for a particular polyarylether ketone/sulphone copolymer. In particular, in a membrane electrode assembly having two gas diffusion layers, two catalyst layers and an ion-exchange membrane interposed therebetween, the ion-exchange membrane comprises an ionomer A-B-C wherein 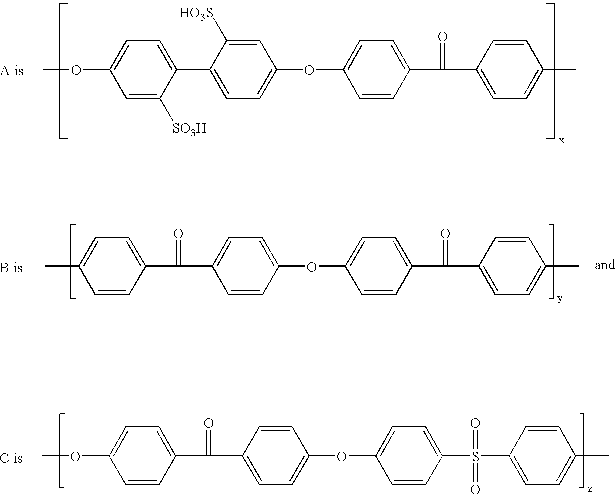
Further, x, y and z represent the mole ratios of each moiety in the ionomer. The value of x corresponds to the equivalent weight of the ionomer (assuming each moiety is sulphonated as indicated) such the equivalent weight increases with decreasing amounts of moiety x. Fuel cell performance is typically related to equivalent weight such that better performance is seen with decreasing equivalent weights (see for example D. Chu, R. Jiang “Comparative studies of polymer electrolyte membrane fuel cell stack and single cell” Journal of Power Sources 80 (1999) 226-234). However, contrary to expectations performance of a fuel cell having the present membrane does not necessarily improve with decreasing equivalent weights for a given membrane thickness. In particular, preferred values of x are between 0.25 and 0.40, for example between 0.29 and 0.37 or between 0.31 and 0.35.

Relative improvements in durability of the fuel cell increases when there is at least some of moiety y present in the membrane. However, manufacturability of the membrane decreases significantly with larger amounts of moiety y present. Thus preferred values of y are between 0.01 and 0.26, for example between 0.08 and 0.20 or between 0.11 and 0.15. The amount of moiety z may then be between 0.40 and 0.67, such as, for example between 0.45 and 0.60 or between 0.51 and 0.56. In an embodiment, x is about 0.33, y is about 0.13 and z is about 0.54.

Another factor which affects reliability and durability of a membrane is a fuel cell is the melt viscosity of the base polymer. The base polymer is the ionomer as discussed above prior to sulphonation of moiety x. The melt viscosity is preferably above 0.4 kNsm⁻², such as, for example above 0.6 kNsm⁻². In an embodiment, the melt viscosity is about 0.6 kNsm⁻² (temperature of 400° C., shear rate of 1000 s⁻¹).

A method of making such a membrane electrode assembly as discussed above comprises casting an ion-exchange membrane from ionomer A-B-C, also as discussed above; providing an anode gas diffusion layer and a cathode diffusion layer; coating an anode catalyst layer on either the anode side of the ion-exchange membrane or the anode gas diffusion layer; coating a cathode catalyst layer on either the cathode side of the ion-exchange membrane or the cathode gas diffusion layer; and bonding the anode and cathode gas diffusion layers to the ion-exchange membrane.

A fuel cell may then be made with any of the MEAs as discussed above. Similarly, a fuel cell stack may be made from a plurality of such fuel cells. These and other aspects of the invention will be evident upon reference to the attached figures and following detailed description.

### BRIEF DESCRIPTION OF THE DRAWINGS

FIG. 1 shows the molecular structure of five polyarylether copolymers.

FIG. 2 is a graph of voltage against melt viscosity of the corresponding base polymer for membranes I and III in a fuel cell.

FIG. 3 is a graph of voltage against current density for membrane III in a fuel cell comparing the performance observed when the MEA is prepared by coating the catalyst layer directly on membrane III with that of an MEA wherein the catalyst layers are coated on the gas diffusion layers.

### DETAILED DESCRIPTION OF THE INVENTION

A large number of ionomers are disclosed in the Victrex Prior Art though there is little actual fuel cell data provided. Within a smaller subset of this larger class of ionomers disclosed, examples are provided wherein various properties are measured such as % water uptake, crystallinity index, equivalent weight, melt viscosity, etc. Some of these properties are predicted to have an effect on fuel cell performance. For example, low equivalent weight, low water uptake and high crystallinity index are desired properties for an ionomer (see for example WO 01/71839 generally regarding crystallinity and at page 2, lines 4-6 regarding equivalent weight and water uptake). Other parameters such as melt viscosity are simply reported as a property of the ionomer. However, it is only through actual fuel cell testing, that the performance and durability of a membrane be truly assessed.

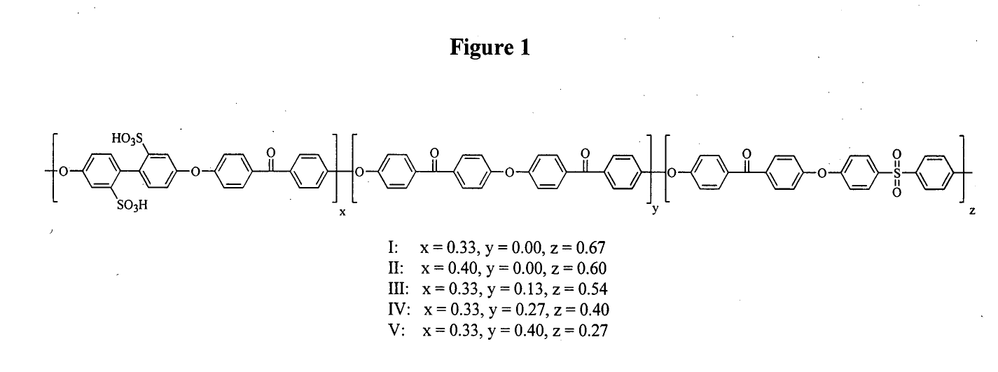

Through extensive fuel cell testing, four specific trends can be seen, particularly within a certain class of ionomer as shown in FIG. 1 where x, y and z show the relative amounts of each moiety in ionomers I, III, IV and V (i.e. the relative mole ratios). The first trend is that lower equivalent weights of the ionomer does not necessarily improve performance. Secondly, processability and membrane quality decreases with increasing amounts of y. Thirdly, the durability of the fuel cell improves with at least some of moiety y present. Finally, fuel cell performance and durability improves with increasing melt viscosity of the base polymer. The base polymer is the ionomer prior to sulphonation of moiety x. From all of these trends, ionomer III with a melt viscosity of the base polymer about 0.6 kNsm⁻² (at 400° C., 1000 s⁻¹) is clearly preferred.

General Procedures

Ionomers of the present invention can be made according to procedures found in the Victrex Prior Art. More particularly, four monomers are used to make ionomers III, IV and V namely: 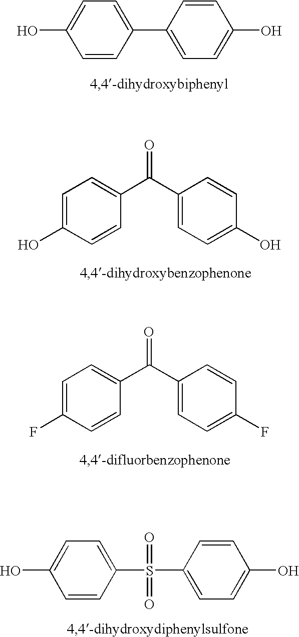
Ionomer I only requires three of the monomers, namely 4,4′-dihydroxybiphenyl, 4,4′-dihydroxydiphenylsulfone and 4,4′-difluorobenzophenone. In synthesizing any of the four ionomers, the relative amounts of 4,4′-dihydroxybiphenyl, 4,4′-dihydroxybenzophenone and 4,4′-dihydroxydiphenylsulfone added determine the relative amounts of x, y and z respectively as provided in FIG. 1. The molar ratio of 4,4′-difluorobenzophenone added may be equal or in slight excess to the molar ratio of the other monomers combined The base polymer of I, III, IV or V may be synthesized using the following general procedure. A 700 ml flanged flask fitted with a ground glass Quickfit lid, stirrer/stirrer guide, nitrogen inlet and outlet may be charged with 4,4′-difluorobenophenone, 4,4′dihydroxybiphenyl, 4,4′-dihydroxydiphenylsulphone, 4,4′-dihydroxybenzophonone and diphenylsulphone and purged with nitrogen for over 1 hour. The contents may then be heated under a nitrogen blanket to between 140° C. and 150° C. to form an almost colourless solution. While maintaining a nitrogen blanket, dried sodium carbonate may then be added. The temperature may then be raised gradually to 320° C. over 3 hours and maintained for 1.5 hours. If the melt viscosity is monitored, the reaction may be stopped at the desired melt viscosity for the base polymer. The reaction mixture may then be allowed to cool, and subsequently milled and washed with acetone and water. The resulting polymer may then be dried in an air oven at 120° C.

The base polymer may then be sulphonated by stirring each polymer in 98% sulphuric acid (3.84 g polymer/100 g sulphuric acid) for 21 hours at 50° C. The reaction solution may then be allowed to drip into stirred deionised water wherein sulphonated polymer precipitates as free-flowing beads. Recovery of the ionomer may be by filtration followed by washing with deionised water until the pH is neutral and subsequent drying. Titration may be used to confirm that 100 mole % of the biphenyl units had sulphonated, giving one sulphonic acid group, ortho to the ether linkage, on each of the two aromatic rings comprising the biphenyl unit. If desired, the sulphonation reaction conditions can be varied to obtain only partial sulphonation of the biphenyl units.

Solutions were then produced from the sulphonated ionomers by dissolving the ionomer in N-methylpyrrolidone (NMP) under the conditions listed in Table 1:

TABLE 1

| | % Solids | Dissolution | Solution Viscosity/ |
|---|---|---|---|
| Ionomer | w/w | Temperature/° C. | cps |
| I | 16 | 60 | 730 |
| II | 14 | 60 | 773 |
| III | 16 | 60 | 740 |
| IV | 16 | 130 | 1066 |
| V | 10 | 140 | 155 |

The solutions were then filtered through a 5-10 μm filter and degassed under high vacuum for one hour at room temperature.

The homogeneous solutions containing ionomers I, II, III and IV were then cast onto a clean glass plate to a 250-500 μm thickness using a doctor blade and allowed to dry at 60-70° C. for approximately 15 hours. The resulting membranes were floated off the glass plates by soaking in a water bath at room temperature, washed in fresh deionized water for one hour and subsequently air dried at room temperature.

Membrane electrodes assemblies were then prepared by bonding with standard electrodes: carbon fibre paper (Toray, TGP-090) screen printed with a carbon sublayer and a total platinum loading of 1.0 mg/cm². The membranes and electrodes were bonded at a temperature of approximately 220° C. for 2 minutes then cooled for 3 minutes under a pressure of 20.0 bar g.

In the following examples, the operating conditions of the fuel cell were as follows: hydrogen pressure 1.2 bara; air pressure 1.2 bara; hydrogen stoichiometry 1.33; air stoichiometry 2.0; temperature 65° C.; air relative humidity 100%; hydrogen relative humidity 0% (hereafter referred to as the “Operating Conditions”).

Equivalent Weight

The equivalent weight of an ionomer is the weight in grams of polymer per mole of sulphonic acid groups present. In this class of ionomer, the amount of sulphonic acid groups present depends on the mole ratio of 4,4′-dihydroxybiphenyl present in the ionomer and the efficiency of the sulfonation reaction. Thus the equivalent weight is inversely proportional to the mole ratio of 4-4′-dihydroxybiphenyl. Ionomer I with a mole ratio of 0.33 of 4,4′-dihydroxybiphenyl has a theoretical equivalent weight of 690 g/mol, whereas ionomer II with a mole ratio of 0.40 has a theoretical equivalent weight of 583 g/mol. Under the Operating Conditions and a current density of 432 mA/cm², fuel cells with membranes made from ionomers I and II gave voltages of 0.493V and 0.365V, respectively. This is a significant difference of approximately 0.13V and contrary to expectations. The sulphonic acid groups are used for hydrogen ion transport through the membrane and thus it would be expected, as stated above and in the Victrex Prior Art, that better performance would be observed with lower equivalent weights for a given membrane thickness wherein the membrane contains more sulphonic acid groups. However, contrary to expectations, better performance is observed with higher equivalent weights and thus lower mole ratios of 4,4′-dihydroxybiphenyl in the ionomer. In particular, better performance is observed where the mole ratio x in the ionomer in FIG. 1 is less than 0.40, more particularly less than 0.37 or less than 0.35. Nevertheless, the sulphonic acid groups still maintain an important role in ion transport across the membrane and thus the mole ratio x may be greater than 0.25, more particularly greater than 0.29 or greater than 0.31.

Mole Ratio of 4,4′-dihydroxybenzophenone

The solubility of this class of ionomer in NMP varied with the amount of 4,4′-dihydroxybenzophenone present. With reference to Table 1 above, the dissolution temperature was increased from 60° C. to 130° C. for ionomer IV and 140° C. for ionomer V due to the decrease in solubility of the polymer. Also as seen in Table 1, only a 10% solids concentration of polymer V was possible even at the elevated temperature. Ionomers I, II and III also produced clear solutions that were stable for more than three months. A clear orange solution was produced with ionomer IV that became cloudy after 10 days and ionomer V produced a dark red solution that became a gel after only 5 days. The stability of a ionomer in solution correlates with its processability and manufacturability.

The results of durability studies in fuel cells operated under the Operating Conditions for 50 μm thick membranes I, III, IV cast from ionomers I, III and IV respectively are shown below in Table 2.

TABLE 2

| Membrane | Trial 1 | Trial 2 | Trial 3 | Average |
|---|---|---|---|---|
| I | 120 hrs | 187 hrs | 470 hrs | 259 hrs |
| III | 400 hrs | 587 hrs | — | 494 hrs |
| IV | 391 hrs | — | — | 391 hrs |

The durability of a particular membrane depends on various factors with the composition of the underlying ionomer being only one such factor. While efforts were made to minimize external variations between trials, a fairly large distribution was still observed. Nevertheless, Table 2 indicates that the presence of at least some 4,4′-dihydroxybenzophenone in the ionomer increases the durability of the resultant membrane. In addition, the melt viscosity of base polymers I and III were each 0.45 kNsm⁻² whereas the melt viscosity for polymer IV was only 0.37 kNsm⁻². As discussed below, melt viscosity has an effect on durability such that the lifetime of membrane IV may be greater if a material with 0.45 kNsm⁻² melt viscosity had been used instead. Nevertheless, in considering both lifetime issues and solubility issues mentioned above, membrane III is clearly preferred. In other words, the mole ratio of 4,4′-dihydroxybenzophenone, which corresponds with y in FIG. 1, is preferably between 0.01 and 0.26, more particularly between 0.08 and 0.20 and even more particularly between 0.11 and 0.15.
Melt Viscosity

Melt viscosity is a measure of a material's resistance to shear flow. For non-Newtonian fluids, which include most polymer melts, melt viscosity varies with both shear rate and temperature. All reported values for melt viscosity are at 400° C. and 1000 s⁻¹ unless otherwise noted. The sulphonated ionomer is liable to decompose with temperature and as such, a melt viscosity cannot be measured. Thus, melt viscosity measurements were taken of the base polymer prior to sulphonation. Further, the reported values are blended averages wherein three different batches of the same base polymer with different melt viscosities were combined to give the base polymer with the reported average melt viscosity.

Table 3 below shows durability data in a fuel cell for 50 μm thick membranes cast from ionomer III having two different melt viscosities of the base polymer, namely 0.45 kNsm⁻² and 0.60 kNsm⁻² and operated under the Operating Conditions.

TABLE 3

| Melt viscosity | Trial 1 | Trial 2 | Average |
|---|---|---|---|
| 0.45 kNsm⁻² | 400 hrs | 587 hrs | 494 hrs |
| 0.60 kNsm⁻² | 1066 hrs | 2012 hrs | 1539 hrs |

On average, the durability of membranes cast from ionomer III was found to be three times as long when the melt viscosity of the corresponding base polymer was 0.60 kNsm⁻² as compared to 0.45 kNsm⁻². While a relatively broad distribution of times was observed, the higher melt viscosity clearly shows a marked improvement in durability of the resultant membrane. An additional durability study was then performed for a fuel cell stack having 24 cells, each cell having a membrane cast from polymer III, with an average thickness of 25 μm and a melt viscosity of 0.60 kNsm⁻² of the corresponding base polymer. Even with thinner membranes, the 24-cell stack lasted 1519 hours before failure.

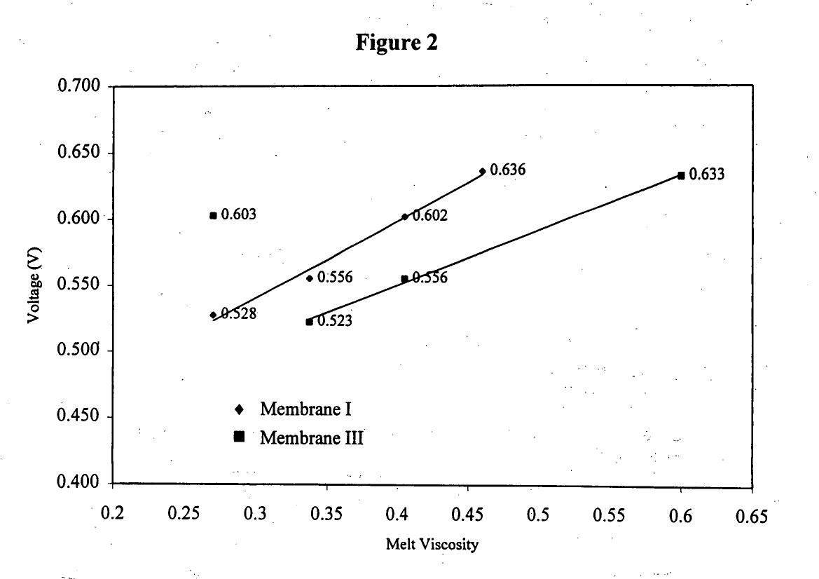

Melt viscosity of the polymer also has a significant effect on fuel cell performance. FIG. 2 shows a linear relationship between voltage and melt viscosity at 432 mA/cm² under the Operating Conditions for membranes cast from both membrane I and membrane III. Increasing the base polymer melt viscosity directly improves fuel cell performance. In particular, improved performances are observed when the melt viscosity is greater than or equal to 0.40 kNsm⁻², such as about 0.60 kNsm⁻² and even as high as 1.3 kNsm⁻², 1.5 kNsm⁻². and 1.7 kNsm⁻².

Through the above fuel cell testing, it was thus possible to determine that ionomer III with a melt viscosity of the base polymer of about 0.60 kNsm⁻² is particularly well suited for use within a fuel cell. It is only through such testing that it can be known how a particular ionomer will function when actually used in a fuel cell.

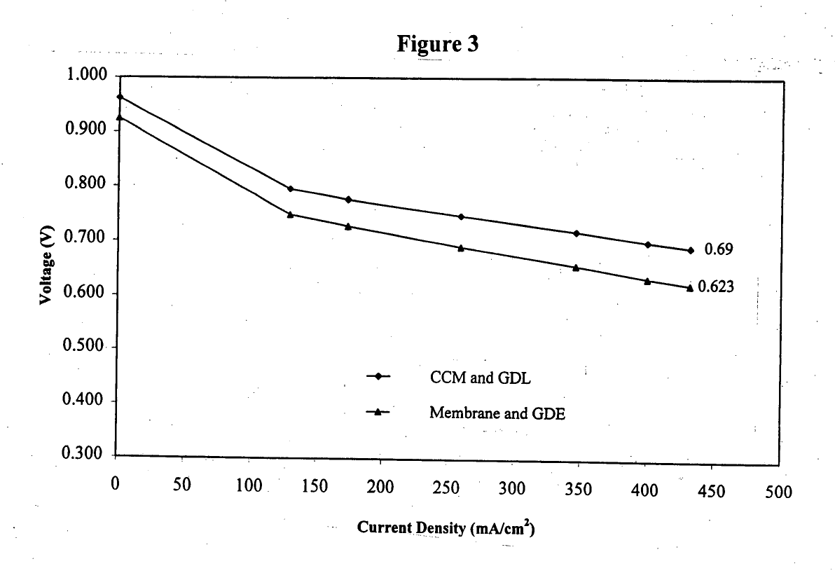

Performance within the fuel cell environment may also be improved by using a catalyst coated membrane (CCM) instead of a gas diffusion electrode (GDE) in preparing the membrane electrode assembly (MEA). In the above examples, the MEA was prepared by bonding the relevant membrane between two gas diffusion electrodes. A gas diffusion electrode comprises a gas diffusion layer (GDL) and a catalyst layer. The GDL in the above examples was a carbon fiber paper (Toray, TGP-090) with a carbon sublayer coated thereon. An alternative method of making the MEA is to coat the anode and cathode catalyst layers directly on the membrane to prepare a CCM and then bond or assemble two GDL thereon. In other words, the catalyst layer may either be coated on the GDL to make the MEA from a GDE or the catalyst layer may be coated on the membrane to make the MEA from a CCM. FIG. 3 illustrates improved performance of an MEA when prepared from a CCM as compared to a GDE. In both cases, membrane III was used in the MEA and similarly manufactured. Results were obtained under the Operating Conditions. Without being bound by theory, the improved performance may be due to better contact between the catalyst layers and the ion-exchange membrane when the catalyst layers are coated directly on the ion-exchange membrane. It is also understood that an MEA could also be prepared by coating one catalyst layer, either the anode or the cathode on the ion-exchange membrane and coating the other catalyst layer on a gas diffusion layer.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

1. A membrane electrode assembly having two gas diffusion layers, two catalyst layers and an ion-exchange membrane interposed therebetween wherein the ion-exchange membrane comprises an ionomer A-B-C wherein 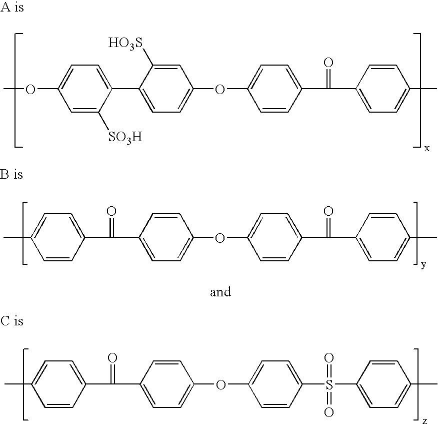
and wherein x is between 0.25 and 0.40; y is between 0.01 and 0.26; and z is between 0.40 and 0.67.

2. The membrane electrode assembly of claim 1 wherein x is between 0.29 and 0.37.

3. The membrane electrode assembly of claim 1 wherein x is between 0.31 and 0.35.

4. The membrane electrode assembly of claim 1 wherein y is between 0.08 and 0.20.

5. The membrane electrode assembly of claim 1 wherein y is between 0.1 1 and 0.15.

6. The membrane electrode assembly of claim 1 wherein z is between 0.45 and 0.60.

7. The membrane electrode assembly of claim 1 wherein z is between 0.51 and 0.56.

8. The membrane electrode assembly of claim 1 wherein x is between 0.31 and 0.35; y is between 0.11 and 0.15; and z is between 0.51 and 0.56.

9. The membrane electrode assembly of claim 1 wherein the ionomer A-B-C is made from a base polymer having a melt viscosity greater than 0.4 kNsm⁻² at 400° C., 1000 s⁻¹.

10. The membrane electrode assembly of claim 1 wherein the ionomer A-B-C is made from a base polymer having a melt viscosity greater than or equal to 0.6 kNsm⁻² at 400° C., 1000 s⁻¹.

11. The membrane electrode assembly of claim 1 wherein the ionomer A-B-C is made from a base polymer having a melt viscosity of about 0.6 kNsm⁻² at 400° C., 1000 S⁻¹.

12. The membrane electrode assembly of claim 8 wherein the ionomer A-B-C is made from a base polymer having a melt viscosity of about 0.6 kNsm⁻² at 400° C., 1000 s⁻¹.

13. An electrochemical fuel cell comprising the membrane electrode assembly of claim 1.

14. An electrochemical fuel cell stack comprising a plurality of fuel cells of claim 13.

15. A method of making a membrane electrode assembly comprising:
casting an ion-exchange membrane from an ionomer A-B-C wherein 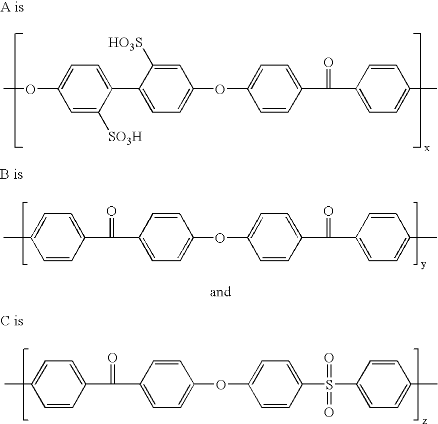
and wherein x is between 0.25 and 0.40; y is between 0.01 and 0.26; and z is between 0.40 and 0.67, the ion-exchange membrane having an anode side and a cathode side;
providing an anode gas diffusion layer and a cathode gas diffusion layer;
coating an anode catalyst layer on the anode side of the ion-exchange membrane or on the anode gas diffusion layer;
coating a cathode catalyst layer on the cathode side of the ion-exchange membrane or on the cathode gas diffusion layer; and
bonding the anode and cathode gas diffusion layers to the ion-exchange membrane to form a membrane electrode assembly.

16. The method of claim 15 wherein x is between 0.31 and 0.35; y is between 0.11 and 0.15; and z is between 0.51 and 0.56.

17. The method of claim 16 wherein the ionomer A-B-C is made from a base polymer having a melt viscosity of about 0.6 kNsm⁻² at 400° C., 1000 s⁻¹.

18. The method of claim 15 wherein at least one of the anode and cathode catalyst layers are coated on the ion-exchange membrane.

19. The method of claim 15 wherein both the anode and cathode catalyst layers are coated on the ion-exchange membrane to form a catalyst coated membrane.

20. A membrane electrode assembly prepared by the method of claim 19.

21. A fuel cell comprising the membrane electrode assembly of claim 20.

22. A fuel cell stack comprising a plurality of fuel cells of claim 21.
